(19) United States
(12) Patent Application Publication
(10) Pub. No.: US 2015/0366185 A1
(43) Pub. Date: Dec. 24, 2015

(54) NOVEL CHITIN / DEMINERALISED DEHYDRATED CHITINACEOUS / CRUSTACEAN EXOSKELETON -BASED FORMULATION CONTAINING MICROBES THAT GENERATE CHITINASE / PROTEASE ENZYMES

(71) Applicant: PELICAN BIOTECH & CHEMICAL LABS PVT. LTD., Kerala (IN)

(72) Inventors: Manoj Chuzhattil NARAYANAN, Cherthala (IN); Priya Raghavendra RAO, Cherthala (IN); Thomas JACOB, Kottayam (IN)

(73) Assignee: PELICAN BIOTECH & CHEMICAL LABS PVT. LTD., Cherthala (IN)

(21) Appl. No.: 14/764,441

(22) PCT Filed: Jan. 29, 2014
(86) PCT No.: PCT/IB2014/058629

§ 371 Date: Jul. 29, 2015

(30) Foreign Application Priority Data
Jan. 30, 2013 (IN) 414/CHE/2013

(51) Int. Cl. A01N 25/08; A01N 63/04

(52) U.S. Cl. CPC A01N 25/08; A01N 63/04

(57) ABSTRACT

The invention is a new product where the chitin or demineralised dehydrated chitinaceous/crustacean exoskeleton acts as a substrate for the microbes and also induces the production of chitinase/protease enzymes. The enzymes will act on the chitinaceous exoskeleton of pathogenic insects and fungus providing pesticidal activity. This invention also brings out a novel product which comprises of chitin or demineralised dehydrated chitinaceous/crustacean exoskeleton with chitinase/protease enzymes along with microbes that produce chitnase/protease enzymes.

### FIELD OF INVENTION

The invention is a new product comprising of biopolymer chitin or demineralised dehydrated chitinaceous/crustacean exoskeleton and microbes that produce chitinase/protease enzymes.

The invention is a new product where the chitin or demineralised dehydrated chitinaceous/crustacean exoskeleton acts as a substrate for the microbes and also induces the production of chitinase/protease enzymes. The enzymes will act on the chitinaceous exoskeleton of pathogenic insects and fungus providing pesticidal activity. Chitin or demineralised dehydrated chitinaceous/crustacean exoskeleton populated with microbes are used as a bio-control agent that can be used in all agricultural applications.

This invention also brings out a novel product which comprises of chitin or demineralised dehydrated chitinaceous/crustacean exoskeleton with chitinase/protease enzymes along with microbes that produce chitnase/protease enzymes.

### BACKGROUND OF INVENTION

The invention brings out a novel product comprising of chitin or demineralised dehydrated chitinaceous/crustacean exoskeleton with microbes that produce chitinase/protease enzymes.

The prior art is use of chitin as a good agricultural soil/root product. The prior art uses chitin as a soil ingredient which may induce chitinase/protease enzymes production in field condition. The limitation of the prior art is that additional microbes need to be added to induce chitinase which may not be acclimatised in the new environment. The present invention overcomes this limitation by the use of chitin or demineralised dehydrated chitinaceous/crustacean exoskeleton populated with microbes that produce chitinase/protease enzymes. There are no prior art on microbes populated in chitin or demineralised dehydrated chitinaceous/crustacean exoskeleton.

Another prior art is to use charcoal/talc/liquid broth as substrate to inoculate and supply biopesticidal microbes. The disadvantage of the prior art is that additional chitinaceous matrix that helps in in-situ chitinase enzyme generation has to be added as a separate component. The present invention proposes a product in which the microbes are allowed to grow in chitin/demineralised dehydrated chitinaceous/crustacean exoskeleton which helps in chitinase/protease enzymes generation thereby populating both the enzymes as well as the microbes progressively unlike as in charcoal/talc where they remain dormant

The prior art of using biopesticidal fungi like Trichoderma viride and Beauveria bassianainvolves providing as inocula in a solid or liquid substrate. The disadvantage of the prior art is that the microbes are not active in the inert un-reactive matrix and does not produce any biopesticidal enzymes unless introduced in the field, creating delay in action. The present invention proposes a new product that not only contains inoculum but also contains chitinase/protease enzymes produced by the microbes in the chitnaceous substrate thereby providing instant effect. The microbes in the product as described in the present invention are active due to the presence of biopolymer chitin or demineralised dehydrated chitinaceous/crustacean exoskeleton which provide the nutrients for microbial proliferation in the amorphous matrix resulting in enhanced insecticidal activity.

The present invention provides for a product where the microbes and the chitinase/protease enzymes are populated in demineralised dehydrated chitinaceous/crustacean exoskeleton or on chitin. These enzymes will degrade the exoskeleton of pathogenic insects and fungi providing pesticidal activities.

### OBJECT OF THE PRESENT INVENTION

An object of this invention is to provide a completely organic, eco-friendly, non-toxic chitin-based bio-control agent for the in-situ generation of chitinase/protease enzymes for use against insects in the soil/roots of the plants. This product can be used in all agriculture applications.

Another object of this invention is to use chitin or demineralised dehydrated chitinaceous/crustacean exoskeleton as a matrix, with microbes producing chitinase/protease enzymes for use in the in-situ generation of chitinase/protease enzymes and thereby using it in bio-control applications in agriculture.

Yet another object of the invention is to provide a new product that not only contains inocula but also contains chitinase/protease enzymes produced by the microbes.

### DESCRIPTION OF THE INVENTION

According to this invention, there is provided an amorphous matrix consisting of versatile biopolymer chitin or demineralized dehydrated chitinaceous/crustacean exoskeleton in combination with chitinase/protease enzymes-producing microbes including fungi like Trichoderma viride and Beauveria bassiana, to be used as biocontrol/biopesticidal agents for application in the field of agriculture.

Fresh chitinaceous/crustacean exoskeleton is soaked in 5% hydrochloric acid for four hours to get demineralised(DM) chitinaceous/crustacean exoskeleton. The demineralised shell is then subjected to solvent extraction using acetone to obtain dehydrated demineralised shell (DM-DH) shell. The DM-DH shell, after acetone extraction, is subjected to deproteinization using 3-5% sodium hydroxide and then washed to neutral pH and dried to obtain chitin. Chitin or DM-DH shell can be used for the preparation of the product.

To 12 grams of potato dextrose broth, add 500 ml distilled water. Sterilize the media in an autoclave. Allow it to cool to room temperature. Innoculate the pure culture with microbes that produce chitinase/protease enzymes. Keep the inoculated media in a rotary shaker for 72 hours. Filter the broth and mix together. Pour the mixed broth into 1 kg of chitin/DM-DH flakes. Air dry the sample with loss of drying not less than 10%.

The invention will now be illustrated with working examples.

It is to be understood that the specific example being given here by way of illustration and are not intended to be taken restrictively to imply any limitation on the scope of the present invention.

### Example 1

Fresh prawn shell (15 kg) was demineralised using 5% Hydrochloricacid and then dehydrated to obtain dehydrated Demineralised (DM-DH) shell. This shell was subjected to deproteinization using 3-5% sodium hydroxide. The shell obtained was washed to neutral pH and dried to obtain chitin. This was used as the matrix for the formulation. To 24 grams of potato dextrose broth added 1 liter of distilled water. Sterilized the media in an autoclave. Allowed it to cool to room temperature. Added the fungal inoculum of Trichoderma viride or Beauveria bassiana into the media. Kept in rotary shaker for 72 hours. Filtered the broth and poured 100 ml of the broth into 1 kg chitin flakes. Air-dried the mixture to LOD (loss on drying-moisture) content not less than 15-20% and gave an assay of Microbial load of 10⁸ cfu/gm and Chitinase enzyme activity: not less than 1U/gds

### Example 2

Fresh prawn shell (15 kg) was demineralised using 5% Hydrochloricacid and then dehydrated to obtain dehydrated Demineralised (DM-DH) shell. This DM-DH shell was the matrix in the preparation of the present formulation. To 24 grams of potato dextrose broth added 1 liter of distilled water. Sterilized the media in an autoclave.

Allowed it to cool to room temperature. Added the fungal inoculum of Trichoderma viride or Beauveria bassiana into the media. Kept p in rotary shaker for 72 hours. Filtered the broth. Poured 100 ml of broth into 1 kg of DM-DH flakes. Air-dried the mixture to loss on drying moisture content LOD not less than 15-20% and gave an assay of Microbial load 10⁸ cfu/gm and Chitinase enzyme activity not less than 1 U/gds

1-10. (canceled)

11. An amorphous matrix as a substrate for chitinase/protease producing microbes, wherein the amorphous matrix is a demineralized, dehydrated chitinaceous/crustacean exoskeleton/dehydrated crustacean exoskeleton.

12. The amorphous matrix as claimed in claim 11, wherein the chitinase/protease producing microbes include the fungi Trichoderma viride and Beauveria bassiana.

13. The amorphous matrix as claimed in claim 11, wherein the total microbial load is not less than 10⁸ CFU/gm, having a chitinase enzyme assay of 1 U/gds.

14. The amorphous matrix as claimed in claim 11, wherein the amorphous matrix is a flake or powder.

15. The amorphous matrix as claimed in claim 11, wherein the amorphous matrix is a nutrient source for chitinase/protease producing microbes.

16. The amorphous matrix as claimed in claim 11, wherein chitinase/protease producing microbes degrade the amorphous matrix and chitin-containing pathogenic insects and fungi.

17. A process for the preparation of the amorphous matrix of claim 11, comprising:
a. demineralizing the crustacean exoskeleton with 5% hydrochloric acid;
b. subjecting the demineralised crustacean exoskeleton to solvent extraction for dehydration to obtain the demineralized/dehydrated crustacean exoskeleton;
c. optionally subjecting the demineralized/dehydrated crustacean exoskeleton of step (b) to deproteinization using 3-5% sodium hydroxide;
d. adding chitinase/protease producing microbes containing broth to either to the product of step (b) or (c); and
e. air drying the mixture of step (d), wherein the moisture content lost on drying is no less than 15-20%.

18. The process as claimed in claim 17, wherein the chitinase/protease producing microbes containing broth is obtained by inoculating the fungal inoculum into a sterilized potato dextrose medium and incubating for 72 hours in rotary shaker.

19. Use of the amorphous matrix of claim 1, as a substrate for inoculating chitinase/protease producing microbes.

20. Use of the amorphous matrix with the chitinase/protease producing microbes of claim 19, as a bio-control agent.
